(19) United States
(12) Patent Application Publication
(10) Pub. No.: US 2026/0350431 A1
(43) Pub. Date: Nov. 5, 2026

(54) SYSTEMS AND METHODS FOR MOBILE-BASED CERTIFICATION OF COLLECTIBLE ITEMS USING ARTIFICIAL INTELLIGENCE

(71) Applicants: Thomas J. McWilliams, Bryn Mawr, PA (US); Ryan T. McWilliams, Bryn Mawr, PA (US)

(72) Inventors: Thomas J. McWilliams, Bryn Mawr, PA (US); Ryan T. McWilliams, Bryn Mawr, PA (US)

(21) Appl. No.: 19/665,404

(22) Filed: May 1, 2026

Related U.S. Application Data
(60) Provisional application No. 63/798,198, filed on May 1, 2025.

(51) Int. Cl. G06N 5/02; G06Q 30/018

(52) U.S. Cl. CPC G06N 5/027; G06Q 30/018

(57) ABSTRACT

A system and method of certifying a collectible item. Included are: an app on a user's mobile device providing a user interface (UI) that enables at least access to: a network communicative with an internet; an account of the user; a library of ones of the collectible items of the user; and a plurality of rules for the certification; an artificial intelligence (AI) engine at least partially remote from and accessible to the app over the network, the AI engine providing the plurality of rules for the certification, wherein the plurality of rules includes at least first rules for the certification when the collectible item is local to the user's mobile device, and second rules for the certification when the collectible item is remote from the user's mobile device; and a hardware add-on for affecting operation of hardware of the user's mobile device via the app to apply ones of the first rules.

### CROSS-REFERENCE TO RELATED APPLICATION

This application claims the benefit of priority to U.S. Provisional App. No. 63/798,198, filed May 1, 2025 and entitled “SYSTEMS AND METHODS FOR MOBILE-BASED CERTIFICATION OF COLLECTIBLE ITEMS USING ARTIFICIAL INTELLIGENCE”, the entirety of which is incorporated herein by reference as if set forth in its entirety.

### BACKGROUND OF THE DISCLOSURE

### Field of the Disclosure

The present disclosure relates generally to item authentication, certification, and grading, and more specifically to systems, methods, and apparatuses for performing these functions through mobile device platforms enhanced with artificial intelligence and hardware add-on components.

### Description of the Background

In the prior art, the authentication, certification, and grading (collectively also “certification”) of collectible items—such as sports cards, autographs, memorabilia, coins, stamps, comics, and similar articles—have been traditionally carried out by specialized third-party “grading companies”. Examples of such companies include Professional Sports Authenticator (PSA), Beckett Grading Services (BGS), Sportscard Guaranty (SGC), and James Spence Authentication (JSA), among numerous others. Typically, these services require that collectors and sellers physically submit collectible items to centralized grading facilities correspondent with each of these companies. Once submitted, certification is typically performed manually by human graders. That is, upon receipt by the grading entity, the item undergoes manual inspection by one or more human graders or authenticators, who may apply visual, tactile, and sometimes forensic examinations to determine authenticity and assign a grade or certification status. This certification generally applies established grading standards for the recognized item type, which may include those standards and testing known to the human grader in receipt of the item. Some companies, such as Hybrid Grading Approach (HGA) and Transparent Authentication Grading (TPA), do advertise the use of some digital review in their certification efforts, but with manual human oversight.

However, these existing systems and methods for collectible certification suffer from numerous disadvantages. First, certification services in the prior art frequently involve significant time delays, with mailing and processing times often ranging from several weeks to several months. Second, the requirement to physically ship valuable collectible items exposes owners to risks of loss, theft, or damage during transit. Third, such systems are costly, particularly for high-value items or for owners with large or diverse collections, as service fees are commonly scaled according to the estimated value of the submitted item. For example, certification of large or diverse collections (e.g., collections containing a mix of cards, memorabilia, autographs, shoes, artwork, etc.) may be prohibitively expensive and logistically complex, in part due to the need to send items from such collections all over the country to many different authenticators, under current models. Fourth, geographic limitations further exacerbate accessibility issues, as collectors in remote or underserved areas face additional logistical challenges in submitting items for grading.

Moreover, these prior art methodologies rely heavily on subjective human interpretation and/or subjective human oversight in the authentication and grading process. Despite efforts toward standardization, this subjectivity inherently leads to inconsistent grading outcomes, disputes, and market uncertainty, especially given that it is necessarily the case that graders, even at the same company, have varying levels of experience and expertise. These disadvantages are further exacerbated by the lack of transparency into the certification process in current certification/authentication models, which also leads to perceived inconsistencies, perceived biases, and consequent disputes regarding grading outcomes.

Further, existing grading models are very ill-suited to the demands of online commerce, where buyers must often rely solely on seller-provided descriptions or pre-existing but unfamiliar or irreputable certifications, which lack any capability for real-time or near-real-time verification of an item's authenticity, and which thereby lead to the sale of fake items and sales disputes. This also results in buyer uncertainty and buyer hesitancy, particularly for uncertified items for sale/auction, and these factors decrease the number of prospective buyers and thereby decrease ultimate sales prices.

Some large-scale sellers, such as eBay and numerous auction houses, have attempted to address these issues with online sales/auctions by offering their own certification processes (i.e., eBay's “Authenticity Guarantee”), but these certifications often attach only to the highest-value items (for example, for sports cards on eBay, the Authenticity Guarantee attaches only to items over $250), thereby exposing still-expensive but lower value items to fraudulent sales. Yet further, these selling-house authentications suffer from many of the same drawbacks as referenced above, i.e., added time to process the certification, the risk of mailing valuable items, and the need for human involvement in the certification process, even in cases where such selling-house certifications are offered for free.

Still further, existing online-sale workflows generally rely on a fixed set of seller-supplied images that may be stale, reused from a prior transaction, digitally manipulated, or not demonstrably linked to the same physical item later shipped to a buyer. Known systems typically lack any reliable liveness protocol, challenge-response capture sequence, or persistent item-level fingerprint by which a later-presented item may be matched back to an earlier certified item, making slab swaps, item substitution, and listing-image spoofing difficult to detect.

Collectively, these deficiencies and drawbacks create substantial inefficiencies, increased costs, risks, and barriers to market participation and difficulties in the avoidance of fraud for collectors, sellers, and buyers. Accordingly, there exists a need in the art for improved systems and methods that provide rapid, cost-effective, accurate, and accessible certifications of collectible items, without the drawbacks inherent with traditional third-party grading services. The disclosed embodiments address these and other needs, offering transformative improvements over prior systems by leveraging mobile technologies, artificial intelligence, in-situ testing hardware, and cloud-based resources in a convenient, efficient, and cost-effective single system and method.

### SUMMARY OF THE DISCLOSURE

The present disclosure provides systems, apparatuses, and methods for the certification/authentication/grading of collectible items through a mobile device platform/app, an artificial intelligence (AI) engine, and optional hardware add-on components.

In embodiments, a user operates a mobile device that runs an app configured to facilitate collectible item certification. The app provides a user interface enabling access to a network, a user account, a digital library of collectible items, and a plurality of certification rules. The mobile app is communicatively coupled to an AI engine that is at least partially cloud-based, that generates and applies the certification rules, in part based on whether the collectible item is local to or remote from the mobile device (e.g., is accessed via the mobile device camera locally, or through online images or auction links).

In conjunction with the app, the hardware add-on may be provided to the user. The hardware add-on interfaces with the mobile device's existing camera and lighting hardware, and optionally includes optical components such as a black-blue light filter and a magnification lens, to enhance image capture and inspection capabilities. Through the hardware add-on, digital filters for remote items, and the app interface, in-situ and remote certification tests may be conducted under control of the AI engine.

The AI engine governs the certification process by applying pre-loaded and dynamically-learned rules for recognition, authentication, and grading of collectible items. For in-situ items, physical testing, such as may be enabled by the hardware add-on(s), is performed by the user. For remote items, the AI engine applies digital analysis methods, including virtual lighting, magnification, and/or photo manipulation detection. The AI engine continuously updates its certification rules and accuracy by accessing third-party data, marketplace results, and trusted authentication sources, including learning from human graders at a reputable certification/authentication/grading entity, thereby enabling a self-improving certification system.

Upon certification, collectible items may be digitally associated with digital or paper certification, such as metadata, a digital letter, an image archive, or optionally a blockchain-anchored certificate, to provide immutable proof of authenticity as well as, optionally, ownership history/chain of title.

In additional embodiments, the AI engine generates, from multi-angle imagery and digital or in-situ test results, an item-specific digital fingerprint comprising one or more relatively invariant features of the collectible item and/or its holder, such as print-registration traits, edge/chip patterns, gloss distribution, autograph stroke geometry, label typography, serial data, weld lines, and other microfeatures. The digital fingerprint may be used to reidentify the same item in later submissions, sales listings, or resale events, thereby helping detect substitution, slab switching, tampering, or recertification of a different item using prior images or metadata.

In further embodiments, the app may execute a guided capture or challenge-response protocol for in-situ or remote users, such as by requiring capture of prescribed views, angles, lighting conditions, motions, reference targets, timestamps, or user prompts within defined time windows. Such liveness-guided capture may reduce photo reuse and digital spoofing, improve comparison fidelity across sessions, and enhance confidence that a later-shipped item corresponds to the item actually analyzed.

In still further embodiments, the hardware add-on may include or cooperate with a dedicated excitation source, such as a violet and/or ultraviolet emitter, such as a UV flashlight or pen light, and the AI engine output may include an explainability package identifying which tests, features, and confidence sub-scores most influenced the certification and whether human escalation, such as a physical send to a provider of the proprietary app, is recommended.

Also included in the embodiments may be a method of certifying a collectible item. Included in such a method may be: receiving, at an app executed on a mobile device, image data and metadata associated with the collectible item; recognizing, by an AI engine, an item type of the collectible item; selecting, by the AI engine, a certification protocol based on the item type, historical fraud patterns, and available testing capabilities; guiding capture of additional data for the collectible item using at least one of a camera of the mobile device, a hardware add-on, or a digital filter; generating an authenticity output and an item-specific digital fingerprint; and issuing a digital certificate tied to images and metadata of the collectible item.

Still further included in the disclosure may be a non-transitory computer readable medium storing instructions that, when executed by one or more processors, cause performance of operations comprising: receiving images and metadata of a collectible item from a mobile-device app; recognizing the collectible item; selecting a certification protocol based on item type, fraud history, and available testing capabilities; analyzing the collectible item using at least one of digital filtering, guided image capture, or hardware-add-on-assisted inspection; generating an authenticity output and an item-specific digital fingerprint; and issuing a digital certificate tied to images and metadata of the collectible item.

The disclosed systems and methods provide a substantial improvement over traditional collectible item grading services, offering greater accessibility, reduced cost, minimized transit risk, real-time or near-real-time certification, and increased transparency and consistency.

### BRIEF DESCRIPTION OF THE DRAWINGS

The foregoing purposes and features, as well as other purposes and features, will become apparent with reference to the description and accompanying figures below, which are included to provide an understanding of the disclosure and constitute a part of the specification, in which like numerals represent like elements, and in which:

FIG. 1 graphically depicts aspects of the disclosure;

FIG. 2 graphically depicts aspects of the disclosure;

FIG. 3 graphically depicts aspects of the disclosure;

FIG. 4 graphically depicts aspects of the disclosure;

FIG. 5 graphically depicts aspects of the disclosure; and

FIG. 6 graphically depicts aspects of the disclosure.

### DETAILED DESCRIPTION OF THE DISCLOSURE

It is to be understood that the figures and descriptions of the present disclosure have been simplified to illustrate elements that are relevant for a clearer comprehension of the present disclosure, while eliminating, for the purpose of clarity, many other elements found in similar systems and methods. Those of ordinary skill in the art may thus recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is nevertheless directed to all such variations and modifications to such elements and methods known to those skilled in the art.

Unless defined otherwise, all technical and scientific terms used herein have the same meaning as commonly understood by one of ordinary skill in the art to which this technical subject matter belongs, and are intended to encompass similar and equivalent terminologies for the subject matters disclosed, unless noted otherwise. And although any methods and systems similar or equivalent to those described herein can be used in the practice or testing of the present disclosure, exemplary methods and systems are described.

As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

The steps, processes, and operations described herein are not to be construed as necessarily requiring their respective performance in the particular order discussed or illustrated, unless specifically identified as a required order of performance. It is also to be understood that additional or alternative steps may be employed, in place of or in conjunction with the disclosed aspects.

“About” as used herein when referring to a measurable value such as an amount, a temporal duration, and the like, is meant to encompass variations of ±20%, ±10%, ±5%, ±1%, and ±0.1% from the specified value, as such variations are appropriate. Further, throughout this disclosure various aspects of the disclosure can be presented in a range format. It should be understood that the description in range format is merely for convenience and brevity and should not be construed as an inflexible limitation on the scope of the disclosure. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Processor-implemented modules and systems are disclosed herein that may provide access to and transformation of a plurality of types of digital content, including but not limited to data and data streams, and the algorithms applied herein may track, deliver, manipulate, transform, transceive and report the accessed digital content. Described embodiments of the engines, modules, apps, systems and methods are intended to be exemplary and not limiting.

An exemplary computing processing system for use in association with the embodiments, by way of non-limiting example, is capable of executing software, such as an operating system (OS), applications (which may be referred to herein, particularly for mobile devices, as “apps”), user interfaces, and/or one or more other computing algorithms, such as the algorithms, modules, engines, decisions, models, programs and subprograms discussed herein. The operation of the exemplary processing system is controlled primarily by non-transitory computer readable instructions/code, such as instructions stored in a computer readable storage medium, such as hard disk drive (HDD), optical disk, solid state drive, Random Access Memory (RAM), a flash memory, or the like. Such instructions may be executed within the central processing unit (CPU) to cause the system to perform the disclosed operations. In many known computer servers, workstations, mobile devices, personal computers, and the like, the CPU is implemented in an integrated circuit called a processor.

It is further appreciated that, although the exemplary processing system may comprise a single CPU, such description is merely illustrative, as each processing system discussed herein throughout may comprise a plurality of CPUs. As such, the disclosed systems may also exploit the resources of remote CPUs through a communications network or some other data communications means.

In operation, CPU fetches, decodes, and executes the instructions from the computer readable storage medium. Information, such as the computer instructions and other computer readable data, is transferred between components of the computing system via the system's main data-transfer path.

The herein described user display/graphical user interface (UI) may be used to display visual output and/or presentation data generated by or at the request of processing system, such as responsive to operation of the aforementioned computing programs/app. Such visual output may include text, graphics, animated graphics, and/or video, for example. Similarly, audio output may be provided.

Further, the processing system may contain a network adapter which may be used to couple to an external communication network, which may include or provide access to the Internet, an intranet, an extranet, or the like, such as the “cloud”. The communications network may provide the processing system with means of communicating and transferring software, data and/or any information electronically. Network adaptor may communicate to and from the network using any available wired or wireless technologies. Such technologies may include, by way of non-limiting example, cellular, Wi-Fi, Bluetooth, infrared, or the like.

The disclosure is and includes a computing device, a mobile device, and components thereof, and operating system(s) thereof, and an app associated therewith. Although the disclosed device, components, and app may include and/or have access to independent artificial intelligence (AI) features, those AI features may be used solely to contribute to the training and learning models implemented by the AI on the device and the app discussed herein. That is, the device disclosed herein, the app thereon, and any hardware add-on(s) attached thereto provide novel aspects unknown in the prior art, and AI may simply contribute to, rather than forming the basis of, these novel features.

Those of skill in the art will appreciate that the various illustrative logic, modules, and algorithmic steps described in connection with the embodiments disclosed herein may be implemented as electronic hardware, computer software, or combinations of both. To clearly illustrate this interchangeability, various illustrative components, blocks, engines, modules, circuits, and steps are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

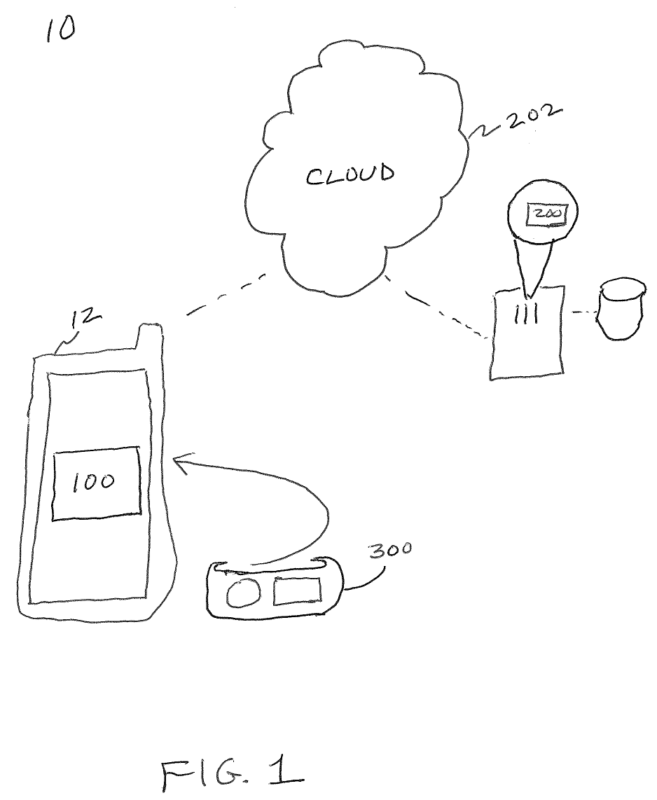

The embodiments include apparatuses, systems and methods of authenticating, certifying, and/or grading (herein also collectively referred to as “certification”) collectible items. Using the disclosed apparatuses, systems and methods, anything currently subject to certification, authentication and/or grading, including but not limited to clothing, shoes, artwork, entertainment and sports memorabilia, autographs, postcards, sports cards, books, stamps, coins, breweriana, remote and point of sale advertising and marketing items, and so on, which may be readily certified using the disclosed embodiments. To that end, the embodiments may include a system 10 having an “app” 100, a backend/AI engine 200, and optionally one or more hardware add-ons 300, as illustrated in FIG. 1.

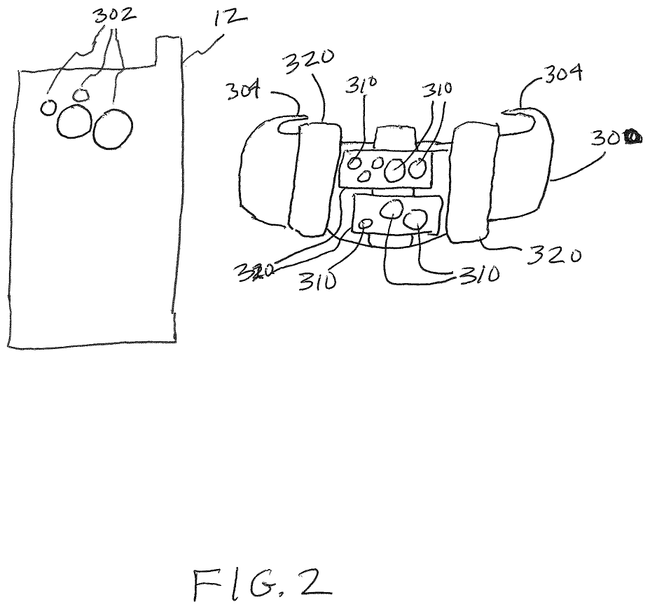

The hardware add-on may increase the certification capabilities of a mobile device for collectible items in-situ with the user. More specifically, the hardware add-on 300, as illustrated with particularity in FIG. 2, may interface, interact, and/or otherwise use the mobile device's provided hardware 302, such as its flash/flashlight, camera lens(es), and so on, to enable in-situ features of the certification methodologies and systems described herein. The add-on may preferably be passive, but in some alternative cases may be active, i.e., powered, such as by on-board battery power, plug in, or wireless/contact power received from the adjacent mobile device's battery. Alternatively, the hardware add-on(s) may comprise a kit of one or more hardware items, such as a magnifier, infrared (IR) light, such as an IR flashlight, or ultraviolet (UV) and/or blue/black light, such as a UV flashlight, by way of non-limiting example, some, none, or all of which may be physically associated with or disassociated from the mobile device during use in the embodiments.

The add-on may readily physically associate with a mobile device and/or other computing device in-situ with the user, or may remain, in whole or in parts, disassociated physically from the local device, in part so that the disclosed systems and methods can be easily used in any situation, whether the user wishes to perform an authentication/certification/grading in her home, at a memorabilia show, or at a retail establishment. Thus, the hardware add-ons may be enabled, in whole or in part, to simplistically attach to the local computing device. By way of example, the hardware add-on may slide, clip, or otherwise have an association feature 304 to physically associate onto a mobile device. When properly attached, the hardware add-on may align a filter and/or lens 310, such as a black-blue light lens/filter or other light spectrum filer, over the flashlight 302 of the mobile device 12, and/or may also provide a filter or lens 310, such as a magnifier, over the camera lens (or lenses) 302 of the mobile device. Alternatively and as referenced, none, some, or all of the hardware add-on(s) may be provided as a kit that may be associated with the local device, such as wherein a UV or IR flashlight is used with a disassociated magnifier lens provided in the kit, or wherein the magnifier slides over or otherwise associates directly with the lens of the camera of the local device. As such, a hardware add-on may be uniquely suited to each of different types of mobile devices (i.e., Apple's iphone versus Samsung's Android-based phone), or may be configurable/adjustable 320. By way of example, the attachment of the hardware add-on(s) may provide adjustable fit features 320 such as an adjustable attachment clip, and lenses/filters may be provided on slotted (for positional locking) sliders that allow for positional changes to and/or reconfiguration of the lenses/filters to match with the position of the mobile device's hardware, such as the mobile device's camera lens(es) and flashlight(s).

Moreover, an attachment that holds the hardware add-on 300 itself to the mobile device may have extendable arms that slide horizontally or vertically, similar to a phone tripod mount. Yet further, spring-loaded tensioners may keep the add-on snug once clipped, or adjustment knobs, such as small thumbwheels, may allow micro-adjustment to the clip width or height, so as to fit devices of different thicknesses and sizes. Likewise, magnets within the hardware add-on may allow for attachment and refined adjustment of placement for devices having metal backs.

The filter/lens 310 features of the add-on may likewise be adjustable, such as using the aforementioned sliders and slots, such as a grooved rail in which the user slides the lens/filter 310 along the rail until it locks over the camera or flash of the device. Alternatively, the filter/lens features 310 may likewise be adjustable/switchable, such as in relation to magnification power or lensing, even if the filter/lens remains physically disassociated from the phone and is used in-situ with the phone's embedded lighting or lenses. By way of example for an associated hardware addon lens/filter 310, click-stop detents along the rail may allow for incremental adjustments, and tightening knobs may secure the lens/filter after adjustment. In an additional and alternative embodiment, a rotating dial or turret may house multiple ones of the lenses/filters 310. In such an embodiment, the user spins the dial to bring the desired lens (black-blue light, yellow light, red light, dual aperture, magnifier of certain power, magnifier with lighting, normal clear, etc.) over the flashlight(s) and/or camera lens(es) of the local device.

Although the exemplary embodiments herein focus on lenses and filters, and particularly magnifying lenses or microscope lenses (such as 5×-100× to assess ink types, printing dots, or fabric fiber ID, such as for dot pattern ID, ink bleeding, or signature pressure to provide high-confidence level testing for cards, stamps, coins, autographs, and jerseys) and black-blue light filters, the testing features 310 provided by the hardware add-on are not limited to these examples. By way of non-limiting example only, the physically associated or disassociated testing features provided via the hardware add-on(s) may also be or include: a white light diffuser, such as for surface finish and texture inspection to highlight micro-scratches, corner wear, and surface inconsistencies; a milky polycarbonate dome or matte diffuser panel that provides soft, even lighting to expose wear patterns on glossy surfaces like cards, coins, or graded slabs, which enhances surface grading and tamper detection (e.g., resealed slabs or reglossed cards); a magnetic field sensor to detect embedded security threads or ink tags used in newer memorabilia, money, or modern cards (such as Panini's micro-printed foil), such as a neodymium magnet that may be coupled with a Hall effect sensor to run activation tests, and/or to detect fake embedded features that lack magnetic response, and/or as an anti-counterfeiting tech; an infrared (IR) filter and light pair to detect alterations, glue residue, and forgeries not visible in visible spectrum, such as may be formed of a small IR LED next to the flashlight and a switchable IR-pass filter for the camera lens to provide IR to reveal underlying materials or erased markings, especially on paper collectibles (e.g., altered autographs) by adding a second spectral channel (beyond visible and black-blue/UV) with forensic utility; a side-angled light such as a small LED mounted at 15°-30° angle to reveal raised inks, stamps, or debossed embossing by using shadows and light contrast to, for example, help identify live signatures versus printed, or identify impressions from real stamping; and/or a reagent patch mount, such as a swappable chemical patch visible to the phone camera to add chemical testing for counterfeit inks, added inks, or oxidation.

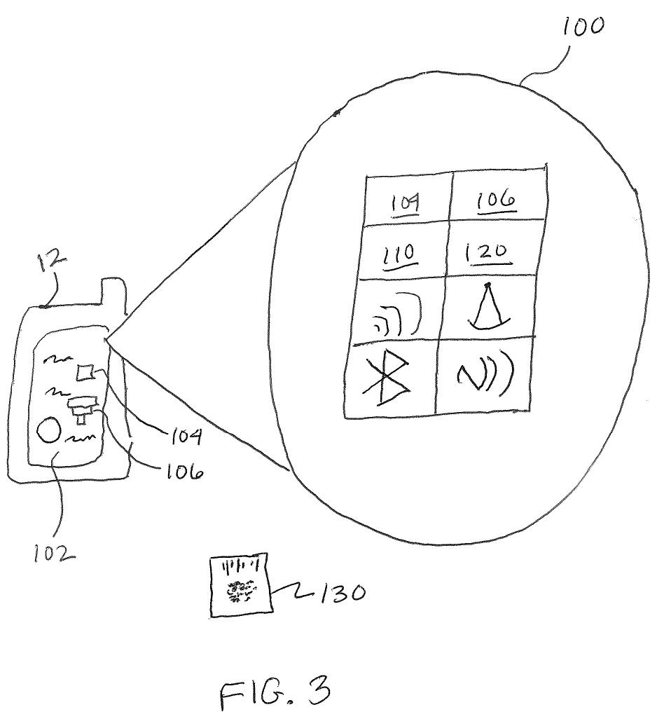

The app 100, as illustrated in FIG. 3, may reside, at least in part, on a local computing device, such as particularly a local mobile device 12. The app may provide a user interface (UI) 102 to enable the user to interface with the disclosed systems and methods. Among other interactions, the UI may enable the user: to attempt a certification of an online item, or item for which only pictures (and, in some cases, description) are available to the user 104; or attempt a certification of an in-situ item 106. More specifically, among other interactions, the user may use the UI to: enter a link, or auction item number and auctioneer, for an item for sale or on auction; to enter/take pictures and/or description of a remote item, such as an item for sale or on an auction site; to enter/take pictures of an in-situ item, such as including pictures taken using the hardware add-on (and with the user following the instructions from the app/AI as to the use of the hardware add-on); and/or to enter such additional information as may be instructed by the app/AI as needed to make a certification.

Further, the UI may enable creation of a user account 110, such as to provide: information on and/or a collection library of the user, and specifically the user's account/login information and a memorabilia collection/use records/watched/purchased/owned library as tracked by the app in the user's account; payment, such as for services provided by the app and/or for the hardware add-ons, such as in a kit, as discussed throughout, which payment section may comprise per-use payment methodologies, a subscription payment methodologies such as for a weekly, monthly, or annual subscription, a purchase of tor within he app, and/or a purchase of the add-on or secondary hardware, by way of example; and a user agreement regarding the foregoing information and to allow for access by the app to control of the phone's hardware (may be either at account creation or on a per-use basis) particularly if needed for the hardware add-ons.

Further, in order to increase the efficiency of operation of the hardware add-on for a specific mobile device, the app may include a self-calibration mode 120 for the hardware of the mobile device that allows a user to calibrate settings, such as the hardware add-on, camera lens and light settings, of the mobile device particularly for optimal certification accuracy based on use of the hardware add-on with that specific mobile device. This is distinct from most current mobile apps, which assume, for example, that all cameras on a particular type of mobile device operate identically, and thus all operate well enough to act identically as the means to accomplish the goal of a given app. On the contrary, the present mobile app may provide for a recognition that even minor camera/flashlight differences may affect certification (which, again, includes authentication and grading, as applicable in given cases, as used throughout) accuracy, and that software corrections to the mobile device's hardware operation can correct these adverse effects on certification. In embodiments, an assessment by the app of the mobile device's camera/light operation may be informed by, for example, viewing through mobile device hardware of printed calibration cards 130 provided with the hardware add-on/add-on kit. That is, the camera and light may be operated by the app upon the calibration card(s), and the output received by the app may then indicate the digital adjustments needed to calibrate the device's camera/light for optimal certification (or may save the necessary adjustments in the user's app account, so that those adjustments are applied to the data generated from the device for each attempted certification).

In additional embodiments, the calibration card 130 may include spectral, fluorescent, phosphorescent, grayscale, gloss, and/or geometric reference regions, including one or more regions having a known response under violet, ultraviolet, infrared, and/or grazing-angle illumination. The app may use captured responses from these reference regions to normalize device-to-device differences in flash spectrum, white balance, camera sensitivity, lens distortion, focus, exposure, and fluorescence capture, and to determine whether a dedicated excitation source or alternate protocol should be selected for a particular mobile device.

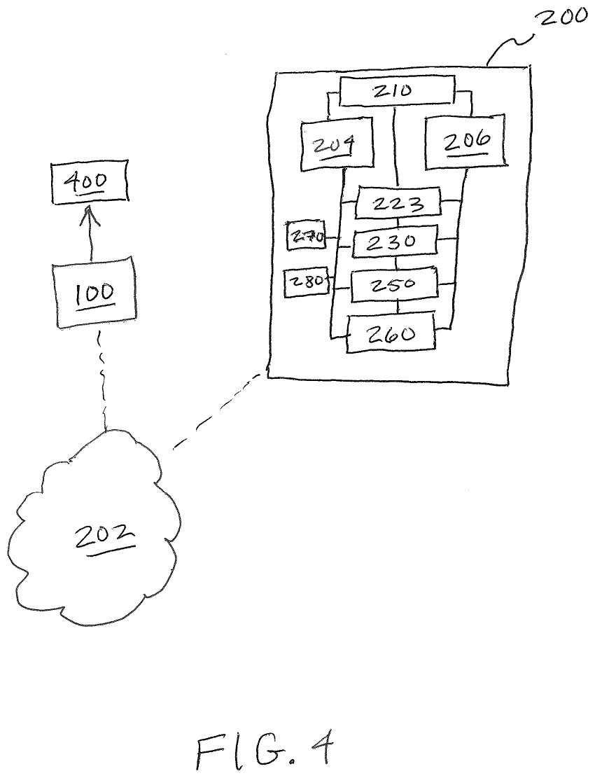

The AI engine 200, as illustrated in FIG. 4, may be part of a backend for the app, and may be wholly or partly local or remote from the device, such as the mobile device, i.e., may be wholly or partly thick or thin client, such as via the Internet/cloud 202. A remote AI engine backend accessible by the local app via the cloud may be preferable, as it may simplify access to cloud/Web-based information as well as allowing for larger data storage capabilities regarding the user, all or certain memorabilia items, certification training and protocols, and so-on, as discussed herein throughout. The AI engine may provide distinct recognition 204 (to identify and categorize an item such that it can be certified) and particularly authenticating and/or grading aspects 206 of certification criteria and components as applicable (which includes at least authentication of the recognized item, and may, in some embodiments, also include grading of certain items/item types), i.e., one or more recognition rule sets and one or more authentication rule sets may form part of plurality of rules/models 210.

Of course, it will be understood that recognition and authentication/grading may be interrelated by the AI engine. That is, the recognition rule set of rules/models 210 may be, as discussed throughout, based on user-entered information, web-based information, or photos from/use of hardware add-on, to enable the AI engine to refine what the item is that the AI engine is looking at. As discussed throughout this effort may be based on prior recognitions and learnings of the AI engine, which may lead to a layered approach by the AI, i.e., an initial assessment of an item type, then an assessment of an item era, then an assessment of the item features, and so on. Once an item is recognized, the universe of rules to assess authenticity (and then grade the item, if applicable) may obviously be limited by the AI engine to only those rules/models applicable to that particular item or item type. This is certainly key for processing efficiency, particularly for items of first impression for which the AI engine has not previously developed a series of tests to apply to an item, at least because any web/cloud scraping need only comprise searching by the AI engine for authenticity hallmark testing for that particular item, rather than for large numbers of items. Likewise, to the extent the rules/models are trained from “watching” manual graders, only the particular item or item type for which that training was observed need to be accessed. Once item recognition rules and testing and authenticity (and, optionally, grading) rules and testing for that particular item, are developed, i.e., after the case of first impression for any particular item, the AI engine will have learned a rule set/testing for that item, such as from accessing cloud-based testing for that item and/or by accessing learned certification criteria and consistency by “watching” a human or hybrid human/machine grader. The AI engine can then use that knowledge to enhance efficiency in the future, although the AI engine may, continuously or at predetermined intervals, nevertheless perform ongoing scraping/searches/watching/other learning to find any new developments in regard to recognition and authenticity (and grading) models/tests for that particular item or item type. Thus, recognition, authenticity and grading for each item (and item type) in the embodiments is completely objective and uniform, and always uses the most up-to-date information on assessment/testing.

The AI engine may include, for example, at least some pre-loaded algorithmic information 210a before application/development of overall training/learning/searching models/rulesets 210 to perform recognition 204 and authentication/grading 206, such as information from watched/learned certifications/authentications/gradings, and/or on the most frequently faked memorabilia, cards, and autographs and the best tests for assessing the validity of these most frequently faked items. In embodiments, the tests selectable by the AI engine, as discussed throughout, will be those tests 223 suited to be performed by the user on her mobile device, such as tests using that specific mobile device's hardware and/or the hardware add-on 300 accessible to that particular user.

The AI may, or may further enable the app to, perform a variety of digital (i.e., software-based) tests 230, some of which may be akin to the tests run by the hardware add-on if the add-on is not available in whole or in part, for an in-situ item, such as an AI picture/pixel review, which may include a variety of digital filtering/tests, such as application of virtualized light filtering to a photograph, electronic magnification of a photo, and so on that allow for application of the AI's preferred tests for a certain item in-situ or to, for example, an auction link or an uploaded photo of that certain item, such as an item that is known to be one of the most frequently faked items. Further, in such cases, the AI engine may test more stringently for items more often faked.

More specifically, while the AI engine obviously can't apply hardware add-on tests to an online item, it can apply hardware add-on-like tests, such as a subset of digital filters and tests, virtually and digitally, which may include variations in lighting, light type or color, contrasting, magnification, as well as detecting photo manipulation (such as might have been used to manipulate the photo to make the item look more attractive) in a manner not currently available to a prospective buyer.

That is, the disclosed digital filtering 230 is not only capable of assessing an item for certification, but also is capable of applying the AI engine's filters to photos, such as auction or sales-site photos, or other digital information to detect signs of fake items, photo manipulation and/or digital fraud. Digital fraud with respect to an item may include use of Photoshop, light/contrast tampering, image stitching, metadata tampering, cloning artifacts, the photo haven been taken with a low level black-blue/UV light shining with a white light to make an autograph “pop”, use of both yellow and white lighting to make a card appear aged, and so on. Needless to say, this digital or real-world manipulation of sales photos is a huge risk in online collectible sales at present, and thus it is a significant advantage that the embodiments offer a risk reduction for this huge concern.

Yet further, tests 220, 230 for items, such as, for example, tests for the most frequently faked items, may be simple information needed by the AI engine that the user can be asked by the app UI (as controlled by the AI). Such information will typically be information that the user can assess using one of the 5 senses, and may then type, speak, or otherwise enter that sensed information to the app to be forwarded to the AI engine to make a decision on recognition or certification. By way of example, because disconnected corners on the box on the back of a 1928 Fro-Joy Babe Ruth sports card are always indicative of a fake card, the user may be asked by the AI engine through the app's UI to simply look at the box, and enter Y/N as to whether the corners of the box are perceptibly disconnected. Further, on the same card, the user may be asked to apply feel and smell tests, where the card is in-situ, or that the user may pose to an online seller, wherein a human is asked to see if the card feels fairly smooth but not glossy, and/or smells musty/aged.

For items not associated with pre-loaded information and not otherwise known to the AI (such as by being pre-loaded or comprising prior testing results or learned certification/authentication/grading from human graders), the AI may access, for example, search capabilities 250, such as Web/cloud-scraping technologies, which enable a wholistic search for the unique item, including online picture mapping akin to Google Lens, and more particularly of the known best methodologies available to assess whether the item is fake or real. Such methodologies may include tests to be run using the hardware add-on, tests the AI is capable of implementing digitally as mentioned above, and/or unique features of the particular item that the user may assess that clearly indicate whether it is real or fake (i.e., a 2011 Topps Update Mike Trout card with his name in black print on the back of the card is always fake).

Training may not only be initial, such as by web-scraping and watching human authenticators, but may also continue with additional web scraping 250 and human grader watching, and further with feedback 260. For example, if a certified item is later deemed fake by a trusted authenticator, the AI models 210 may update automatically. Further, to the extent an AI engine is proprietary to, for example, a well-established grading entity, that entity may continuously update its own models based on updated understandings and based on feedback. That is, the AI engine may learn from its mistakes and those of others, thus strengthening future certifications. Thereby, the AI engine of the embodiments provides a self-improving, long-term accuracy advantage over static authentication and/or manually-updated authentication.

Moreover, the certification output may be explainable and factorized rather than purely conclusory. By way of example, the AI engine may output not only an overall authenticity and/or grade conclusion, but also sub-scores or findings for print characteristics, fluorescence response, ink behavior, stock or substrate traits, autograph stroke depth, image-tampering likelihood, holder integrity, provenance consistency, and/or listing-risk indicators. Such factorized outputs may be stored with the certification record and may be used to determine whether automatic certification is permitted or whether escalation to a human authenticator is warranted.

To enable the foregoing testing, the app (and its instructing AI engine backend) may include item recognition capabilities 204, as mentioned above. More particularly, simple item recognition 270 may comprise simple user entry of the item to the app (AI), and/or simple recognition of an item by, for example, entry of an auction item link. Simple recognition may use, for example, text entry (by the user) or text recognition (such as in a link or search) and/or may be menu driven, such as wherein a user may select a category (i.e., card, autograph, shoes, jersey, etc.), and may thereafter be presented with successively more detailed options in subsequent menus related to that category (i.e., for a card, the user may then be asked the year range of the card, the maker of the card, and the player on the card, such as in successive menus).

Complex item recognition 280 may be within the purview of the AI engine. In such a case, the AI may do a comparative recognition, such as using a provided picture of the item, or by taking a picture such as via the mobile device's camera with or without use of the hardware add-on, and comparing the digitized picture to pre-loaded items, or to returned results from a Web search with parameters set by the AI for the search based on the AI's assessment of the item, such as by category. The outcome may be returned to the user as a confirmed recognition, as an approximate recognition (such as with a confidence interval), or as a series of most-likely possible recognitions each with a successive confidence interval. In the latter two cases, the user may confirm the recognition, or may be enabled by the UI to provide the AI with instructions and request another attempt at recognition, with or without entry of additional parameters. Moreover, as discussed throughout, to the extent the user has, for example, purchased the hardware add-on up-front and a subscription to a proprietary app from an established authentication entity, if the doubt level for certification exceeds a given threshold, only then may a certification be kicked to the need to send the item physically to the certifier, and even then that physical certification may be offered at a discount based on the user's subscription to the certifier app, by way of non-limiting example.

Complex recognition may further entail application of mobile device hardware and/or hardware add-on tests to an item, and/or the aforementioned digital tests to an item. These tests may either directly reflect a particular item or a portion thereof, or may help the AI sequentially delineate the features of the item in sequence to progressively arrive at a recognition/certification. In the latter case, for example, the series of tests/filters may include black-blue light or other testing for fluorescence of the inks on a card (pre-1970s inks shouldn't fluoresce, post 1970s inks do); magnification to assess ink-jet or dot-matrix printing (technologies that did not exist until the modern era); magnification for general print pattern assessments (i.e., pre-1950s prints often included gray or black dots printed even in “white” areas); and/or magnification to gauge “live ink” on an autograph (i.e., live ink will have thicker areas where signatures double back on the prior stroke).

The veracity of the certification from testing 204, 206 may be heightened by the learnings and models 210 of the AI 200 in the embodiments. For example, the app may instruct the user to take an optimal number of photos at optimal angles to allow for the strongest certification based on the recognized item and/or item type, such as 10 particular photos for a vintage Pabst beer neon sign, such as at particular different angles/light conditions. The AI engine may then build a 3D model having an enhanced “multi-view” analysis for the certification. This is distinct from many grading services, and particularly those that rely solely on photos (e.g., the Quick Opinion for autograph certification available from Beckett Grading Services), which generally rely only on one or few 2D static photos. By synthesizing multiple views in 3D, the disclosed AI engine better detects fakes, tampering, or alterations (such as altered corners or edges on cards, or stitching on jerseys, by way of example).

Similarly, the inspection/tests 204, 206 instructed by the AI 200 and provided by the app 100 using, for example, the hardware add-on, may be guided. For example, when examining an item using the hardware add-on, the app may overlay hints provided on the mobile device screen, such as may be dependent on the mobile device type, item type, unrecognized item, or a particular item. Such hints may be of the form, for example, of “Focus here for print inspection” on the back of a sports card, or “Scan here to assess the presence of stitching anomalies” for jerseys or shoes. Thus, unlike the known art, the embodiments may not use static instructions (i.e., “now take a photo of the front”) but instead may use dynamic, in-field guidance to aid in certification. This may be particularly valuable for users with little or no certification experience, users with little experience using the disclosed system and method, and/or especially for difficult to certify items.

In embodiments directed to remote-item evaluation, the app may further request that a seller or other remote user to execute a liveness sequence rather than merely supplying static photographs. By way of example, the AI engine may request capture of a front view, a rear view, an oblique view, a moving-light sweep, a time-limited close-up of a specified region, a view adjacent a contemporaneously displayed code or token, and/or a view with a calibration target in frame, perhaps even as a prerequisite for upload to the selling app. Failure to satisfy one or more requested liveness conditions may lower confidence, trigger additional prompts, or cause the item to be routed to human review or physical submission.

As referenced throughout, the outcome of tests applied by the AI through the app and/or app control of the hardware add-on may be strictly a certification in the form of an authentication/grading 206 or a recognition 204, but it may also comprise a confidence level and/or a certification recordation 400 for an authentication or a recognition. As such, the outcome may be a recorded certification 400 that can be digitally associated with an item, either strictly or as a confidence interval, and which may be digitally associated with pictures of the item that form part of the certification. That is, the certification may be in digital and/or document letter form 400, with text indicating the veracity of the item, and a picture of the item receiving the certification. This is particularly relevant in cases where the app and the disclosed actions correspond to an established authentication entity offering a proprietary app. Also included with the letter may be a QR code, bar code, numeric code, and/or the like, which may be keyed to an available searchable online database to enable third party verification of the certification upon scanning of the code.

By way of example of digital tying of a certification to an item, the app may generate a blockchain-anchored certificate 400 tied to the item's images and metadata, thereby ensuring immutable proof of certification, as well as an ownership trail, are permanently tied to the item, and as such will always be available anytime and anywhere the item is placed for resale. Moreover, the digitized details associated with that particular item, as assessed by the testing applied, will be unique to that item. Thereby, the credibility and resale value of certified items is greatly heightened and fully secured.

In further embodiments, the certification record 400 may include an item-specific digital fingerprint derived from a plurality of stable observable traits of the item, its container, and/or its label, such as microchipping patterns at corners or edges, print-registration offsets, halftone geometry, surface-gloss maps, autograph crossover pressure regions, label fonts, barcodes, serial-number presentation, slab weld lines, scuff topology, and like features. Thereby, a later-captured candidate item may be compared against the stored fingerprint to confirm that it is the same physical item previously certified, or to detect slab substitution, tampering, relabeling, or relisting of a different item using earlier certification assets.

Moreover, recognized items may be objectively “graded” by the AI, such as part of the authentication/certification, as discussed throughout. Grades may be objectively assessed by the AI, such as by introduction through training of basic grading rubrics, which may then be modified through watched human training, entered human training, and/or through digital training as grades are output and reviews are provided of the grades thus output.

As discussed throughout, the AI may “learn”, such as for the purposes of certification, including grading and authentication, and/or of recognition, by way of comparison to known authentication and/or graded exemplars from particularly trusted sources, be they human graders or online sources; and indeed, may “learn” the identities of those trusted sources and may thus vary the comparisons over time, all as part of testing 204, 206, based on variations in the analysis indicated by those trusted sources. By way of example, the AI may access, or be trained by a human with, known examples of authenticated/graded items and/or how to authenticate/grade those items from major authenticators, and may learn to use only examples graded by the most suitable authenticators for certain items when doing digital comparisons of requested items to known authenticated items. For example, only Beckett grading services will now grade 1928 Fro-Joy Babe Ruth cards; James Spence Authentication is known to be the most preferred authenticator for many autographs; and some grading companies are known to pass a high percentage of fakes of a particular item, such as a Michael Jordan 1986 Fleer rookie card, and thus should not be used be used as positive comparatives for an authentication or grading, particularly for those items. Accordingly, the AI may “learn”, or be trained with as part of its models 210, the most and least preferred authenticators at a given time to use in its comparisons for assessing certified items, and/or for learning the best or worst indicators of authenticity for certain items, and the identification of these most and least preferred authenticators may change as trusted sources (such as may be learned from repeated scrape searches of the cloud) indicate most preferred authenticators change.

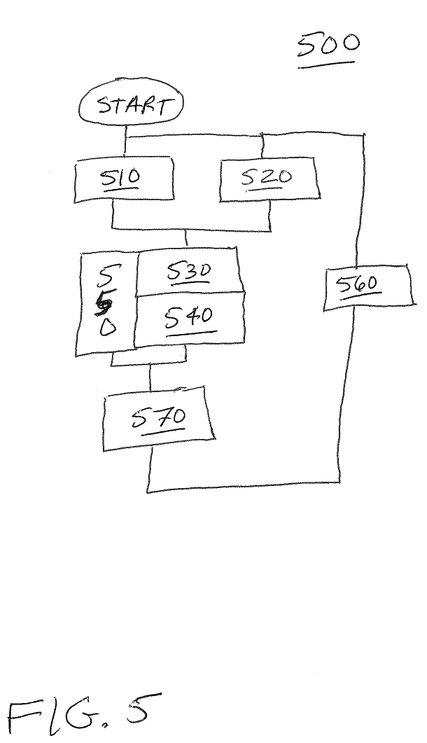

As illustrated in the method 500 of FIG. 5, the AI engine may scrape the web/cloud 510 and/or partner with online marketplaces (i.e., eBay, Goldin, PWCC, Heritage Auctions, etc.) 520 to automate learning of which types 530 of these authenticated items, and certain items and item types as authenticated by whom 540, are most successfully sold (and which aren't), according to any one or more of a variety of different metrics 550, such as for the greatest incremental value over the purchase price or over the smallest time frame from purchase to resale, for example, based on third-party buyer behavior. Such a dynamic learning loop 560 for value increase allows the AI engine, instead of just training on static certified examples, to tune to real-world desirability gradient for certification 570, such as for particular grades, particular grading by whom, and/or for certain items or item types or items corresponded to certain individuals which may or may not also be linked particularly to certain graders (e.g., sports cards of this player from this certifier are selling particularly quickly over the last 60 days, or buyers will generally reject items of this brand with this flaw or feature, from this authenticator, or below this grade, even if authenticated), which maximize value.

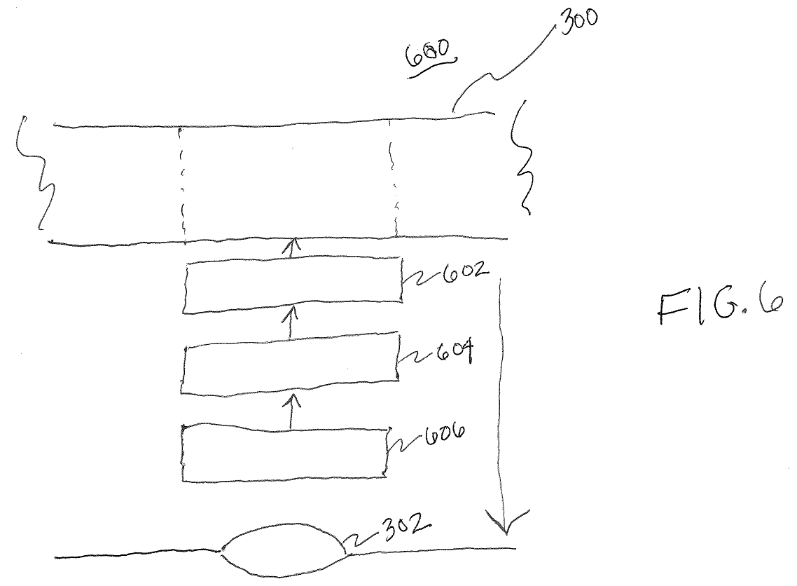

A black-blue, and/or UV, filter/lens is discussed throughout as useful in ones of the embodiments for in-situ collectible item testing. By way of example and as shown in FIG. 6, a multi-layer optical filter 600 may be placed over the mobile device's flashlight 302 to provide black-blue light, or an approximation thereof, as discussed herein. By way of non-limiting example only, the filter 600 may be a small circle or oval shape, such as having a size of ~5-7 mm diameter to best match typical LED flash sizes for current mobile device. The filter may selectively block visible white light wavelengths, allowing primarily black-blue (i.e., UV-A) light to pass through, thereby creating a “purple light” effect that may induce fluorescence in certain inks and materials. As discussed throughout, the presence or absence of fluorescence may be indicative of whether material is vintage, ink is vintage, and whether an autograph is present, and makes certain items, such as ink autographs, much more visible. This allows the embodiments to discern fraudulent or certified items containing such inks or materials.

In some implementations, the foregoing light-filter embodiments may be supplemented by an active excitation source disposed on or within the hardware add-on, such as a 365 nm, 385 nm, 395 nm, 405 nm, or other violet/near-UV LED, laser diode, or micro-emitter, optionally driven by on-board power or power shared from the mobile device. Such embodiments may be advantageous because different mobile-device flashlights may exhibit different spectral content and, in some cases, insufficient energy in a desired excitation band. Accordingly, in certain embodiments the filter may serve to pass or clean desired short-wavelength content emitted by the native flashlight and/or by the dedicated excitation source, while suppressing longer-wavelength visible light, rather than being required to generate wavelengths absent from the source itself.

In an exemplary construction, a first layer 602 of the filter may be a clear polycarbonate or acrylic, or similar suitable construct, to provide the filter/lens physical support and optical clarity. Layer 2 604 may comprise a blocking filter, such as a long-pass UV-A, or, in cases where the base lighting of the phone does not include UV wavelength, a near-UV, optical filter having a passband around, by way of example and when such wavelengths are included in the mobile device's lighting, 365-405 nm. For higher accuracy performance, the passband may be more narrowly centered around 395 nm, if available. This second layer may block most visible white light, and may transmit the aforementioned UV-A/near-UV black/blue light. More particularly, the filter may have a blocking range of about 420 nm and above; that is, light having wavelengths in this range should be highly attenuated (i.e., >OD3 or better).

Optionally, a third layer 606 may be a surface coated material, such as an anti-reflective coating or matte surface, to reduce reflection and glare off of the filter surface to thereby improve illumination of the item. In embodiments, the filter may further include a blue/purple color booster thin film layer to intensify the visual effect of the black-blue light, such as to enhance the ability of a user to recognize the effects of the light.

Thus, the exemplary black-blue light filter lens provided herein may use safe materials, such as UV-stable polymers or glass, to prevent yellowing or degradation over time. The use of polymer-based materials and/or injection molding may make the disclosed filters/lenses highly scalable and inexpensive to manufacture. Such materials are lightweight and durable, which makes this filter/lens highly suitable for use on a mobile device.

Of additional note, dual-flash devices may use, for example, multiple filters or a dual aperture filter. In such a case of dual flash, multiple filters may allow for the providing of different passbands of light, i.e., light from different points on the spectrum, at the same time. This may enable yet further testing of in-situ items for fraud.

As such, the embodiments provide very distinct advantages over known certification services for items. For example, the embodiments may provide instant online or in-situ certification, and thus no weeks-long wait for certification, and no risk of getting lost in the mail when an item is sent to an authenticator/grader for certification, as occurs in the known art.

Moreover, the embodiments differ appreciably from available online recognition tools, such as Google Lens. Among other things, the disclosed system and method operates specifically for authenticating, certifying, and/or grading collectible items (sports cards, autographs, memorabilia, coins, etc.) using trained AI models informed by industry standards, common fakes, and value-based outcomes, whereas tools such as Google Lens are simply general-purpose image recognition tools to perform image searches to generally identify objects. Further, the embodiments go well beyond simple recognition by issuing certifications, optionally with confidence intervals, and with verifiable metadata, blockchain certificates, value-sensitive grading decisions, and, optionally, provenance data. Yet further, unlike Google Lens, the disclosed embodiments include a physical hardware add-on (with UV filters, magnifiers, etc.) to allow forensic-quality, lighting-controlled, and real-world testing of collectible materials.

More particularly, the embodiments thus provide a heightened authentication/certification/grading service over anything provided in the known art, and without the downside of having to physically send items through the mail or drop them at a dropoff site for certification. Accordingly, the embodiments may prove particularly attractive to known certification entities. For example, such current entities may provide the disclosed services, including in-situ and online certifications, on a one-time payment or monthly subscription basis, and may additionally charge rental fees, or an upfront fee, for a hardware add-on kit, such as may include a UV light source, a magnifier, and/or mobile device hardware tuning cards. Further, such entities may keep consumers “in-universe”, at least in that only if an item proves to have an uncertain certification percentage from the AI engine may that item need to be physically sent to that established authenticator who has provided the proprietary app, and at that all necessaries to send the item may be generated from the app for the user, and the user may be provided with a discount for the physical grading, given that the user is already paying monthly for that authenticator's proprietary app. Thus, the user is enticed to use only that grader given the simplicity of the transaction. Further, users who are nervous about sending items regularly through the mail are enticed to use that grader because the grader's proprietary app allows for the vast majority of items to be graded while in possession of the user, and allows for the user to additionally certify online items, as well as items at collectible shows, of interest to the user for purchase, using the app. And finally, those users nervous about using grading services due to the need to send items through the mail will be enticed to use the proprietary app because only a small percentage of items now need to be physically submitted, and even in such cases apps will make the submission far easier and less logistically complex than is the case at present. And even with those positives, the logistics for the grading entity are also greatly simplified, but the profitability is significantly enhanced by the opening of the certification/grading realm to a significant new universe of users.

The embodiments also differ appreciably from CollX, Center Stage, and similar known collection-centric apps. Unlike other apps, the embodiments perform authentication, grading, and certification—not just recognizing an item, but validating its authenticity, optionally assigning a grade, and optionally issuing a verifiable digital certificate (including blockchain-based proof and confidence scoring), while other apps simply perform a visual identification and provide estimated market values without formal or trusted certifications, authentications, or grading, or with the availability of value projections as disclosed herein.

Additionally, the embodiments use an AI trained on the most capable human graders, known fakes and continuous learning about authenticated items to perform image-based and test-based fraud detection, including advanced features like fluorescence analysis, ink type analysis, print pattern or dot analysis, fabric, stock or substrate analysis, and ink consistency and signature depth testing, unlike known apps that use AI only for image classification (e.g., “this looks like a 1991 Topps Ken Griffey Jr.”). Known collectible-centric apps also do not include a corresponded hardware add-on that runs a variety of tests in-situ, and thus neither do the known apps envision the digitization of these tests for application, to the extent possible, to online items (e.g., certification from auction listing photos), with AI-analyzed results of these digitized online tests based on the quality and metadata of those images. Still further and unlike the known apps, the embodiments provide actionable, trusted outputs, such as verifiable digital certification documents, blockchain-linked certificates, records for resale integration and value projection, and QR codes or image-locked authenticity labels. Finally, unlike known apps, the embodiments may provide self-calibration and guided testing, such as calibration cards for the mobile device camera/lighting, AR-style live guidance (e.g., “move phone 2 inches back,” “focus camera here”), and optimized testing sequences per item type, such as may be based on indications gained from web scraping (e.g., particular 10-angle scan of a vintage breweriana sign) in addition to uploaded or affirmatively-taught instructions.

Further, the embodiments offer a certification/authentication/grading such as may be uploaded in online context, such as to appease prospective buyers' concerns and to avoid delays to receive an item while it goes through a sale establishment or an auction house's authenticity guarantee process (in which the item is mailed from the seller to an authenticator, who then takes days to authenticate before an additional number of days during which the item proceeds through snail mail to the buyer), but without the disadvantages in time and cost to gain a certification for association with an item in the known art. That is, the embodiments provide not only substantial improvements in time and efficiency to certification of an item, but even more so provide improvements for users in the incremental cost and time to certify, authenticate, and/or grade larger portions of collections and/or large collections, and/or collections of varying types of items (i.e., one collection that includes sneakers, sports cards, and game-worn jerseys), because the cost of such multi-item or multi-type items certification may be made far less prohibitive by the use of the embodiments.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. To make and use the disclosed aspects, various modifications to the disclosure will be readily apparent to those skilled in the art. Further, any generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed and claimed as follows.

What is claimed is:

1. A system of certifying a collectible item, comprising:
an app on a user's mobile device, the app providing a user interface (UI) that enables at least access to: a network communicative with an internet; an account of the user; a library of ones of the collectible items of the user; and a plurality of rules for the certification;
an artificial intelligence (AI) engine at least partially remote from and accessible to the app over the network, the AI engine providing the plurality of rules for the certification, wherein the plurality of rules includes at least first rules for the certification when the collectible item is local to the user's mobile device, and second rules for the certification when the collectible item is remote from the user's mobile device; and
a hardware add-on initially provided in conjunction with providing of the app, the hardware add-on affecting operation of aspects of hardware of the user's mobile device via the app, and ones of the first rules being applied through the hardware add-on by the app according to the AI engine.

2. The system of claim 1, wherein the hardware add-on includes at least a light filter for interoperation with a flashlight of the user's mobile device, and a magnification lens for interoperation with a camera of the user's mobile device.

3. The system of claim 2, wherein the light filter is a black-blue light filter.

4. The system of claim 2, wherein the light filter comprises a short-wavelength pass filter configured to suppress longer-wavelength visible light and to pass violet, ultraviolet (UV), or near UV excitation light emitted by the mobile device flashlight or by a dedicated excitation source of the hardware add-on.

5. The system of claim 2, wherein the magnification lens is a microscopic magnification lens.

6. The system of claim 1, wherein the first rules and the second rules comprise an assessment of a dot pattern of print on the collectible item.

7. The system of claim 1, wherein the first rules and the second rules comprise an assessment of a stitch pattern of the collectible item.

8. The system of claim 1, wherein the first rules comprise instructions to the user for use of the camera and lighting of the mobile device to assess veracity of the collectible item.

9. The system of claim 1, wherein the library of ones of the collectible items comprises a digital certificate corresponded to veracity of each of the collectible items in the library.

10. The system of claim 1, wherein the app includes a self-calibration mode configured to calibrate camera and flashlight settings of the user's mobile device based on a printed calibration card.

11. The system of claim 10, wherein the printed calibration card includes a pattern or image used by the app to determine focus accuracy, light diffusion, or spectral distortion.

12. The system of claim 1, wherein the hardware add-on enables interchangeable optical elements.

13. The system of claim 1, wherein the hardware add-on includes a magnification lens aligned with the mobile device's camera and mounted on a slidable or pivotable bracket for positional adjustment.

14. The system of claim 1, wherein the hardware add-on includes a black-blue light filter aligned with the mobile device's flashlight and configured to pass violet and/or ultraviolet-A excitation light emitted by the mobile device flashlight and/or by a dedicated excitation source to induce fluorescence in ink or material of the collectible item.

15. The system of claim 1, wherein the hardware add-on includes an adjustable clip or sliding rail mount to align with and fit to varying mobile device models.

16. The system of claim 1, wherein the first rules and second rules include at least one model trained on images of certified authentic and counterfeit collectible items.

17. The system of claim 14, wherein the second rules are trained to identify signs of photographic tampering including light or contrast manipulation, image cloning, and metadata inconsistencies.

18. The system of claim 1, wherein the AI engine is configured to generate a certification to the app comprising a confidence interval indicating a probability of authenticity or percentage accuracy of the recognition.

19. The system of claim 1, wherein the app is configured to allow certification of an online listing by capturing and analyzing images and metadata accessed via an auction link or marketplace listing.

20. The system of claim 1, wherein the AI engine applies, via the second rules, digital filters simulating different features provided by the hardware add-on in the first rules to the captured images and metadata.
